(19) United States
(12) Patent Application Publication
(10) Pub. No.: US 2022/0018979 A1
(43) Pub. Date: Jan. 20, 2022

(54) DEVICES FOR MOUNTING IMAGING DETECTORS

(71) Applicant: Baker Hughes Oilfield Operations LLC, Houston, TX (US)

(72) Inventors: Edward Baus, Akron, OH (US); Randy Austin, Hudson, OH (US)

(21) Appl. No.: 17/371,859

(22) Filed: Jul. 9, 2021

Related U.S. Application Data
(60) Provisional application No. 63/053,889, filed on Jul. 20, 2020.

(51) Int. Cl. G01T 7/00; G01T 3/00

(52) U.S. Cl. CPC G01T 7/00; G01T 3/00

(57) ABSTRACT

A detector assembly including a plurality of sensors. Each sensor may include a tube having a through-bore therein, a wire arranged within the through-bore of the tube, where the wire is electrically insulated from the tube, and a bracket secured along the entire length of the tube configured to provide rigidity along the length of the sensor.

### CROSS-REFERENCE TO RELATED APPLICATIONS

The present application claims priority to U.S. Application No. 63/053,889, filed on Jul. 20, 2020 and entitled “DEVICES FOR MOUNTING IMAGE DETECTORS,” which is hereby incorporated by reference in its entirety.

### FIELD

Devices, systems, and methods are provided for mounting a type of imaging detectors in order to provide structural support to the imaging detectors.

### BACKGROUND

Neutron scattering is a technique which can be used to observe the molecular composition of a sample. In order to detect the phenomenon of a neutron scattering event, a detector must be arranged proximate to the sample in order to collect the positional data neutrons scattered within the sample. A scattering detector arrangement can include a target upon which an energy particle, such as a neutron, impinges and proceeds therefrom as a “scatter.” The arrangement can also include a plurality of detector tubes positioned across an area for receipt of the scattered energy particle (e.g., a scattered neutron). Various properties, characteristics, and other information can be discerned by the scatter impingement location on the detector tubes from a scattering event. The plurality of tubes can be supported on a chassis assembly using support brackets at distinct support points along the length of the tubes.

However, the support brackets may allow different amounts of sag, dip, or the like at different support points of different detector tubes, which can cause variations in measurements by the detector tubes.

### SUMMARY

In an aspect, a detector assembly includes a plurality of sensors. Each sensor may include a tube having a through-bore therein, a wire arranged within the through-bore of the tube, where the wire is electrically insulated from the tube, and a bracket secured along the entire length of the tube configured to provide rigidity along the length of the sensor.

One or more of the following features can be included in any feasible combination. For example, the tube may be charged as a cathode and the wire may be charged as an anode. The bracket may be arranged within a channel of the frame. The bracket may be secured to the frame via at least on bolt. The bracket may be L-shaped or T-shaped. The bracket extends radially outward from the tube. The assembly may further include a first cap arranged on a distal end of the tube and a second cap arranged on the proximal end of the tube, where the first cap and second cap electrically insulate the tube from the wire. The bracket may be configured to structurally stiffen the tube along its length. Each of the plurality of sensors may be may be secured to a first surface at the first cap and a second surface at the second cap.

In another aspect, a sensor includes a tube having a through-bore therein, a wire arranged within the through-bore of the tube, where the wire may be electrically insulated from the tube, and a bracket secured along the entire length of the tube configured to provide rigidity along the length of the sensor.

One or more of the following features can be included in any feasible combination. For example, the tube may be charged as a cathode and the wire may be charged as an anode. The bracket may be arranged within a channel of the frame. The bracket may be secured to the frame via at least on bolt. The bracket may be L-shaped or T-shaped. The bracket extends radially outward from the tube. The assembly may further include a first cap arranged on a distal end of the tube and a second cap arranged on the proximal end of the tube, where the first cap and second cap electrically insulate the tube from the wire. The bracket may be configured to structurally stiffen the tube along its length. The sensor may be may be secured to a first surface at the first cap and a second surface at the second cap. The bracket comprises a radially extending portion and a mounting portion.

### BRIEF DESCRIPTION OF THE DRAWINGS

A brief description of each drawing is provided to more sufficiently understand drawings used in the detailed description of the present disclosure.

FIG. 1A shows a perspective schematic illustration of a detector tube for detecting energy particle impingement according to an exemplary embodiment;

FIG. 1B shows a cross-sectional schematic illustration of the detector tube taken generally along line 1B-1B of FIG. 1A;

FIG. 1C shows a schematic illustration of the detector tube of FIG. 1B arranged on an embodiment of a support frame;

FIG. 2A shows a perspective schematic illustration of a detector tube for detecting energy particle impingement according to an exemplary embodiment;

FIG. 2B shows a cross-sectional schematic illustration of the detector tube taken generally along line 2B-2B of FIG. 2A;

FIG. 2C shows a schematic illustration of the detector tube of FIG. 2B arranged on an embodiment of a support frame;

FIG. 2D shows a schematic illustration of the detector tube of FIG. 2B arranged on an embodiment of a support frame;

FIG. 3A shows a perspective schematic illustration of a detector tube for detecting energy particle impingement according to an exemplary embodiment;

FIG. 3B shows a cross-sectional schematic illustration of the detector tube taken generally along line 3B-3B of FIG. 3A;

FIG. 3C shows a schematic illustration of the detector tube of FIG. 3B arranged on an embodiment of a support frame; and

FIG. 3D shows a schematic illustration of the detector tube of FIG. 3B arranged on an embodiment of a support frame.

It should be understood that the above-referenced drawings are not necessarily to scale, presenting a somewhat simplified representation of various features illustrative of the basic principles of the disclosure. The specific design features of the present disclosure, including, for example, specific dimensions, orientations, locations, and shapes, will be determined in part by the particular intended application and use environment.

### DETAILED DESCRIPTION

Certain exemplary embodiments will now be described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention.

Further, in the present disclosure, like-named components of the embodiments generally have similar features, and thus within a particular embodiment each feature of each like-named component is not necessarily fully elaborated upon. Additionally, to the extent that linear or circular dimensions are used in the description of the disclosed systems, devices, and methods, such dimensions are not intended to limit the types of shapes that can be used in conjunction with such systems, devices, and methods. A person skilled in the art will recognize that an equivalent to such linear and circular dimensions can easily be determined for any geometric shape. Sizes and shapes of the systems and devices, and the components thereof, can depend at least on the anatomy of the subject in which the systems and devices will be used, the size and shape of components with which the systems and devices will be used, and the methods and procedures in which the systems and devices will be used. In addition, the terms “about” and “substantially” are defined as ranges based on manufacturing variations and variations over temperature and other parameters.

A neutron detector module includes a distribution of sensors positioned in a defined array. Each of the sensors can include a supply of a neutron sensitive gas for reacting with neutrons, and this reaction generates ionizing reaction products. In a Helium-3 (He-3) sensor, a neutron reacts with He-3 to produce a triton and a proton. These reaction products deposit their kinetic energy in the gas, creating ion pairs, which separate in the electric field established in the detector where the electrons gain sufficient kinetic energy to ionize other gas molecules, thereby amplifying the electric signal, which results in a measurable current pulse at the output of the detector. The plurality of detector tubes may be supported by some type of support structure that can be generically referred to as a support frame. Often the sensors are detector tubes grouped into sub-groups or bundle packs, with the tubes within each pack fixed relative to each other and each pack commonly secured to the support frame.

The sensors may include a multitude of tubes positioned across an area for receipt of the scattered energy particle (e.g., a scattered neutron). The plurality of tubes can be supported on a chassis assembly using support brackets at distinct support points along the length of the tubes. The neutron detector module can include a multitude of electrical conductors, with each of the conductors positioned in one of the sensors, where the ionizing reaction products generate electric current pulses in the electrical conductors.

Due to the sensitivity of the detector modules, precision of mounting location of the detector tubes/packs may be of at least some importance. In one example, it is desirable to locate (e.g., mount upon the support frame) the detector tubes/pack such that all of the tubes extend with their respective elongate center axes being located within a single plane. However, the support brackets may allow different amounts of sag, dip, or the like at different support points of different detector tubes, which can cause variations in measurements by the detector tubes.

Accordingly, there is a need for improved devices, systems, and methods for mounting detector tubes to a support structure in order to reduce variations in measurements due to deformation in the detector tubes. These types of support structures can include a support bracket, such as a fin, arranged along the entire length of the tube in order to provide rigidity along the length of the sensor. Since the bracket extends along the entire length if the tube, each portion of the tube is similarly supported, which reduces the chance of sagging or deformation of the tube in an unsupported portion if the support brackets were at separate and distinct locations along the length of the tube.

Applications for the present disclosure include for sensors of proportional counters and position sensitive detectors. A proportional counter is a type of gaseous ionization detector device used to measure particles of ionizing radiation. The key feature is its ability to measure the energy of incident radiation, by producing a detector output pulse that is proportional to the radiation energy absorbed by the detector due to an ionizing event. A position sensitive detector operates on the same basic principle as a proportional counter, except that a signal is measured from both ends of the position sensitive detector in order to determine the position of an ionizing event along the length of the sensor. These position sensitive detectors often used closely spaced sensor tubes having smaller diameters when compared to proportional counters in order to increase the position resolution.

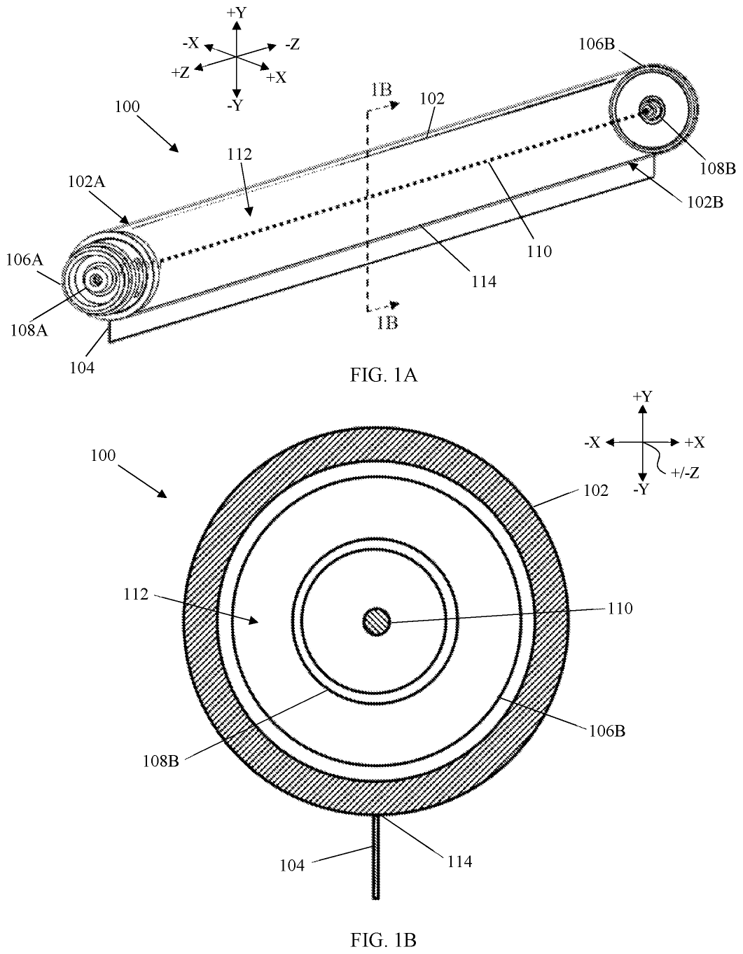

Referring now to FIGS. 1A and 1B, an example image of a sensor 100 is generally depicted according to an exemplary embodiment of the present disclosure. Generally, the sensor 100 includes a tube 102, a support bracket 104, end caps 106A, 106B, and a wire 110. The tube 102 includes a proximal end 102A and a distal end 102B, with the end cap 106A mounted to the proximal end 102A and the end cap 106B mounted to the distal end 102B. The tube 102 may include a through-bore, creating chamber 112 within the tube 102. The chamber 112 may be defined by the tube 102 and the end caps 106A, 106B. The wire 110 is arranged within and extends along the length of the chamber 112. The wire 110 is held in place by wire mounts 108A, 108B, which secure to the ends caps 106A, 106B, respectively. The end caps 106A, 106B may electrically insulate the wire 110 from the tube 102 when either/both are charged.

The wire 110 axially or longitudinally extends through the tube 102 along the Z-axis. In some implementations, the wire 110 is centrally located in the tube and is secured at or adjacent to both ends of the tube 102. The wire 110 extends through the end caps 106A, 106B and may connect to a processor.

After the wire 110 is secured in a tube 102 and the tube is filled with the desired gas or gas mixture, the tube is hermetically sealed by end caps 106A, 106B. Any suitable procedure may be used to do this. The end cap 106A with the wire mount 108A may be used to close one end of the tube 102, with the anode wire 110 extending through that end cap 106A to the exterior of the tube 102, and the end cap 106B with the wire mount 108B may be used to close one end of the tube 102, with the anode wire 110 extending through that end cap 106B to the exterior of the tube 102.

The tube 102 can include a rigid material such as a metal. In some implementations, the housing material can include titanium, aluminum, stainless steel, or alloys thereof. However, the tube material is not limited thereto, and various other materials can be used. The end caps 106A, 106B can also include a rigid material. In some implementations, the end caps 106A, 106B can include the same metal material as the tube 102, with the tube 102 electrically insulated from the end caps 106A, 106B. In some implementations, the end caps 106A, 106B can include a different material from the tube 102. For example, the end caps 106A, 106B can include a ceramic. In some implementations, the sensor 100 may be secured to a wall or surface at the end caps 106A, 106B. For example, the sensor 100 can be suspended within a chamber and mounted to the chamber walls on either side by securing the end caps 106A, 106B to either chamber wall. The support bracket 104 would support the tube 102 and help prevent bending of the tube 102 along its length by increasing its rigidity when mounted from the end caps 106A, 106B.

In some implementations, the distance between the top of wire 110 and the inside surface of the tube 102 is between 0.125-12 inches, and the length of the tube 102 is between 2-120 inches. The tube 102 may have an active length between 1-120 inches. In some implementations, the diameter of the tube 102 is between 0.125-12 inches, and as a more specific example, the diameter of the tube 102 may be between 0.30-0.35 inches. In some implementations, the thickness of the wall of tube 102 is between 0.005-0.090 inches.

In embodiments, the tube 102 and wire 110 have an applied voltage which increases as a charged particle moves from the tube 102 to the wire 110 in order to attract the charged particles towards the wire 110 acting as an anode. For example, the tube 102 may have an applied voltage of 500 V and the wire 100 may have an applied voltage of 2,000 V. Similarly, in another embodiment, the tube 102 may have an applied voltage of −2,000 V and the wire 100 may have an applied voltage of 0 V, being connected to ground.

The sensor 100 is filled with a neutron sensitive gas, such as He-3. While in the operation of the sensor 100, neutrons passing through the sensor 100 interact with the gas in the sensor 100. Also, while in operation, the tube 102 and the wire 110 are charged so that the tube 102 acts as a cathode, and the wire 110 acts as an anode. This interaction results in electrical pulse signals in the wire 110, and the pulses in the wire 110 are collected and analyzed by a processor. The distribution of sensors 100 can include a multitude of tubes.

The support bracket 104 is secured along the entire length of the tube 102 along the Z-axis. The support bracket 104 may be coupled to the tube 102 along seam 114. The seam 114 may be a laser welded portion between the tube 102 and the support bracket 104. The support bracket 104 extends radially outward of the tube 102 in the −Y direction. In some implementations, the support bracket 104 may be the same material as the tube 102, or may be a different, non-conductive material. In some implementations, the support bracket material can include titanium, aluminum, or alloys thereof. However, the housing material is not limited thereto, and various other materials can be used, such as a ceramic.

Due to the relationship between the tube 102 and the support bracket 104 coupled along its entire length, the support bracket 104 stiffens the tube 102 to help prevent distortion of the tube 102 due to a magnetic dipping effect. The magnetic dipping effect is caused by the large potential charge difference between the tube 102 and the wire 110 while the sensor 100 is in operation. If when in operation the tube 102 were to deflect enough to contact the wire 110, the wire 110 would weld itself to the tube 102 due to the large voltages within the components, rendering the sensor 100 useless. Additionally, the arrangement of the support bracket 104 being arranged on the underside of the sensor 100 helps eliminate distortion in the detection signal since neutrons would not need to pass through a bracket arranged on the front side of the sensor 100. This may allow for smaller diameter sensors 100 to be used in a detector array, leading to a finer resolution since the sensors are both straighter and closer together.

FIG. 1C depicts a detector assembly 10 formed from a plurality of sensors 100. With the arrangement of the sensors 100 illustrated in FIG. 1C, the sensors 100 are arranged in parallel rows. The gap between the tubes 102 of adjacent sensors 100 is between about 0.001-0.005 inches, and more specifically set at 0.002 inches. This uniform spatial arrangement may be achieved by mounting the sensors 100 to the frame 120 using support brackets 104. Since the support brackets 104 extend along the entire length of the tube 102, there may be no need for additional support brackets or frames along the length of the tubes 102.

Still referring to FIG. 1C, the frame 120 may further include channels 122 arranged within the frame 120. The channels 122 may correspond to the shape of the support bracket 104 of the sensor 100. The support brackets 104 may be held within the channels using an adhesive, welded material, or mechanical means. For example, a friction fit could be used to couple the sensors 100 to the frame 120. Additionally, a screw or bolt could be used to secure the support brackets 104 to the frame 120.

As will be understood by those of ordinary skill in the art, in different implementations, the detector assembly 10 may be provided with different numbers of the sensors 100, and detector assemblies 10 may be provided with any suitable number of sensors 100 over a wide range of numbers. For example, with some embodiments, the detector assembly 10 may have 1-100 sensors 100. In other embodiments, the module may be provided with different length tubes 102. Other implementations may have more or fewer proportional tubes 100 than those expressly described herein.

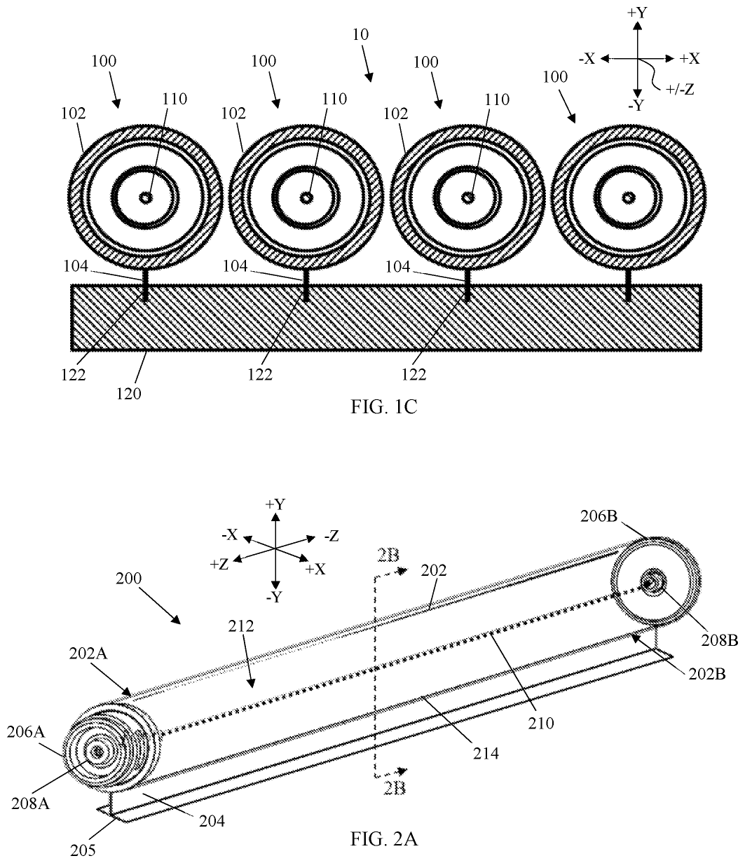

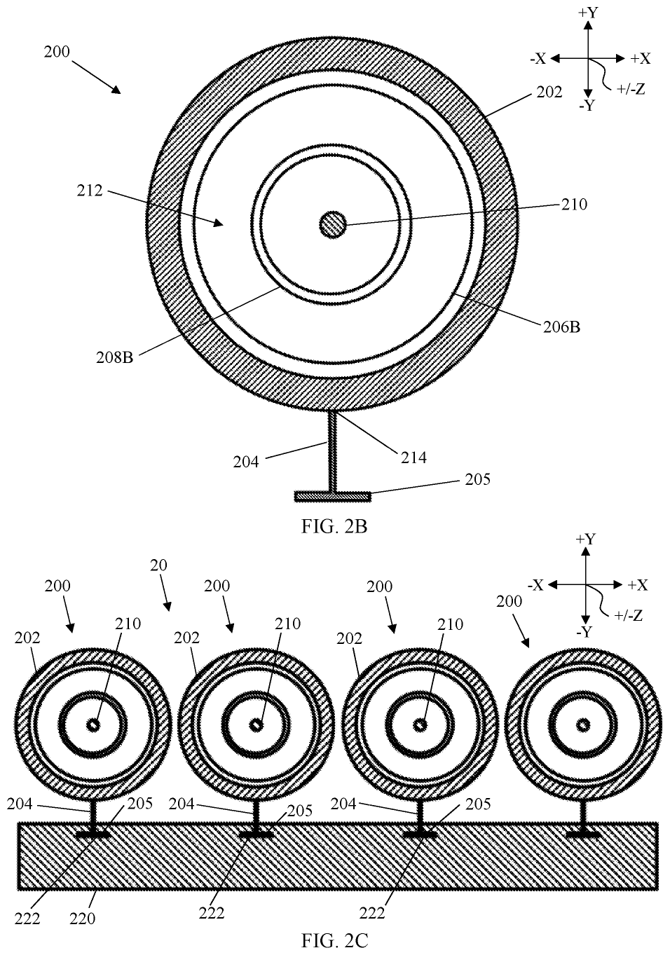

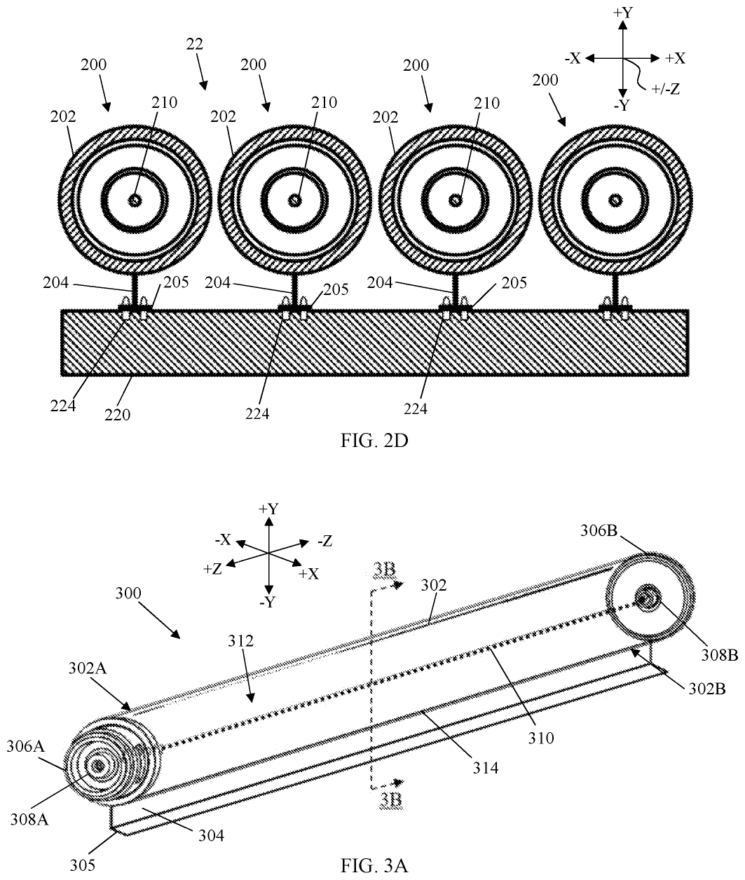

Referring now to FIGS. 2A and 2B, an example image of a sensor 200 is generally depicted according to an exemplary embodiment of the present disclosure. Generally, the sensor 200 includes a tube 202, a support bracket 204, end caps 206A, 206B, and a wire 210. The tube 202 includes a proximal end 202A and a distal end 202B, with the end cap 206A mounted to the proximal end 202A and the end cap 206B mounted to the distal end 202B. The tube 202 may include a through-bore, creating chamber 212 within the tube 202. The chamber 212 may be defined by the tube 202 and the end caps 206A, 206B. The wire 210 is arranged within and extends along the length of the chamber 212. The wire 210 is held in place by wire mounts 208A, 208B, which secure to the ends caps 206A, 206B, respectively. The end caps 206A, 206B may electrically insulate the wire 210 from the tube 202 when either/both are charged. In some implementations, the sensor 200 may be secured to a wall or surface at the end caps 206A, 206B. For example, the sensor 200 can be suspended within a chamber and mounted to the chamber walls on either side by securing the end caps 206A, 206B to either chamber wall. The support bracket 204 would support the tube 202 and help prevent bending of the tube 202 along its length by increasing its rigidity when mounted from the end caps 206A, 206B.

The wire 210 axially or longitudinally extends through the tube 202 along the Z-axis. In some implementations, the wire 210 is centrally located in the tube and is secured at or adjacent to both ends of the tube 202. The wire 210 extends through the end caps 206A, 206B and may connect to a processor.

After the wire 210 is secured in a tube 202 and the tube is filled with the desired gas or gas mixture, the tube is hermetically sealed by end caps 206A, 206B. Any suitable procedure may be used to do this. The end cap 206A with the wire mount 208A may be used to close one end of the tube 202, with the anode wire 210 extending through that end cap 206A to the exterior of the tube 202, and the end cap 206B with the wire mount 208B may be used to close one end of the tube 202, with the anode wire 210 extending through that end cap 206B to the exterior of the tube 202.

The tube 202 can include a rigid material such as a metal. In some implementations, the housing material can include titanium, aluminum, stainless steel, or alloys thereof. However, the tube material is not limited thereto, and various other materials can be used. The end caps 206A, 206B can also include a rigid material. In some implementations, the end caps 206A, 206B can include the same metal material as the tube 202, with the tube 202 electrically insulated from the end caps 206A, 206B. In some implementations, the end caps 206A, 206B can include a different material from the tube 202. For example, the end caps 206A, 206B can include a ceramic.

In some implementations, the distance between the top of wire 210 and the inside surface of the tube 202 is between 0.125-12 inches, and the length of the tube 202 is between 2-120 inches. The tube 202 may have an active length between 1-120 inches. In some implementations, the diameter of the tube 202 is between 0.125-12 inches, and as a more specific example, the diameter of the tube 202 may be between 0.30-0.35 inches. In some implementations, the thickness of the wall of tube 202 is between 0.005-0.090 inches.

In embodiments, the tube 202 and wire 210 have an applied voltage which increases as a charged particle moves from the tube 202 to the wire 210 in order to attract the charged particles towards the wire 210 acting as an anode. For example, the tube 202 may have an applied voltage of 500 V and the wire 200 may have an applied voltage of 2,000 V. Similarly, in another embodiment, the tube 202 may have an applied voltage of −2,000 V and the wire 200 may have an applied voltage of 0 V, being connected to ground.

The sensor 200 is filled with a neutron sensitive gas, such as He-3. While in the operation of the sensor 100, neutrons passing through the sensor 200 interact with the gas in the sensor 200. Also, while in operation, the tube 202 and the wire 210 are charged so that the tube 202 acts as a cathode, and the wire 210 acts as an anode. This interaction results in electrical pulse signals in the wire 210, and the pulses in the wire 210 are collected and analyzed by a processor. The distribution of sensors 200 can include a multitude of tubes.

The support bracket 204 includes a mounting portion 205 and is secured along the entire length of the tube 202 along the Z-axis. In some implementations, the support bracket 204 is T-shaped. The support bracket 204 may be coupled to the tube 202 along seam 214. The seam 214 may be a laser welded portion between the tube 202 and the support bracket 204. The support bracket 204 extends radially outward of the tube 202 in the −Y direction. In some implementations, the support bracket 204 may be the same material as the tube 202, or may be a different, non-conductive material. In some implementations, the support bracket material can include titanium, aluminum, or alloys thereof. However, the housing material is not limited thereto, and various other materials can be used, such as a ceramic.

Due to the relationship between the tube 202 and the support bracket 204 coupled along its entire length, the support bracket 204 stiffens the tube 202 to help prevent distortion of the tube 202 due to a magnetic dipping effect. The magnetic dipping effect is caused by the large potential charge difference between the tube 202 and the wire 210 while the sensor 200 is in operation. If when in operation the tube 202 were to deflect enough to contact the wire 210, the wire 210 would weld itself to the tube 202 due to the large voltages within the components, rendering the sensor 200 useless. Additionally, the arrangement of the support bracket 204 being arranged on the underside of the sensor 200 helps eliminate distortion in the detection signal since neutrons would not need to pass through a bracket arranged on the front side of the sensor 200. This may allow for smaller diameter sensors 200 to be used in a detector array, leading to a finer resolution since the sensors are both straighter and closer together.

FIG. 2C depicts a detector assembly 20 formed from a plurality of sensors 200. With the arrangement of the sensors 200 illustrated in FIG. 2C, the sensors 200 are arranged in parallel rows. The gap between the tubes 202 of adjacent sensors 200 is between about 0.001-0.005 inches, and more specifically set at 0.002 inches. This uniform spatial arrangement may be achieved by mounting the sensors 200 to the frame 220 using support brackets 204. Since the support brackets 204 extend along the entire length of the tube 202, there may be no need for additional support brackets or frames along the length of the tubes 202.

Still referring to FIG. 2C, the frame 220 may further include channels 222 arranged within the frame 220. The channels 222 may correspond to the shape of the support bracket 204 of the sensor 200. The support brackets 204, specifically the mounting portion 205, may be held within the channels using an adhesive, welded material, or mechanical means. For example, a friction fit could be used to couple the sensors 200 to the frame 220.

FIG. 2D depicts a detector assembly 22 formed from a plurality of sensors 200. With the arrangement of the sensors 200 illustrated in FIG. 2D, the sensors 200 are arranged in parallel rows. The gap between the tubes 202 of adjacent sensors 200 is between about 0.001-0.005 inches, and more specifically set at 0.002 inches. This uniform spatial arrangement may be achieved by mounting the sensors 200 to the frame 220 using support brackets 204 and bolts 224. Since the support brackets 204 extend along the entire length of the tube 202, there may be no need for additional support brackets or frames along the length of the tubes 202. A plurality of holes may be arranged within the mounting portion 205 of the support bracket 204, with corresponding holes arranged within the frame 220. The support brackets 204 may also be secured to the frame 220 using an adhesive or being directly welded to the frame 220.

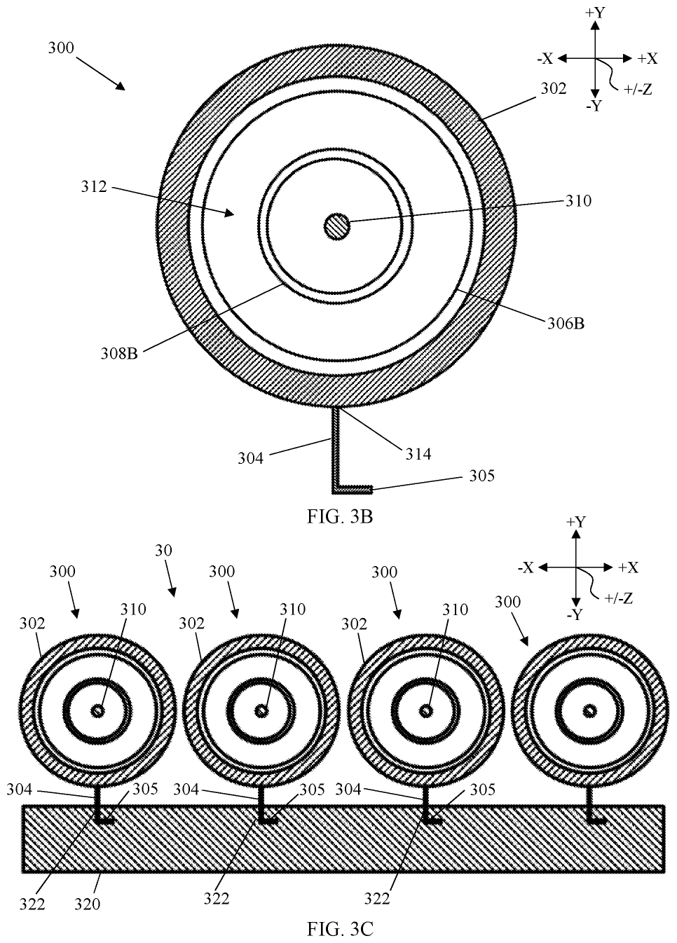

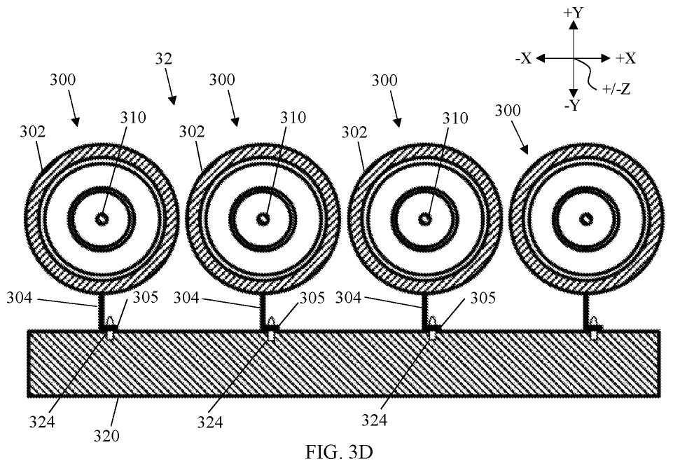

Referring now to FIGS. 3A and 3B, an example image of a sensor 300 is generally depicted according to an exemplary embodiment of the present disclosure. Generally, the sensor 300 includes a tube 302, a support bracket 304, end caps 306A, 306B, and a wire 310. The tube 302 includes a proximal end 302A and a distal end 302B, with the end cap 306A mounted to the proximal end 302A and the end cap 306B mounted to the distal end 302B. The tube 302 may include a through-bore, creating chamber 312 within the tube 302. The chamber 312 may be defined by the tube 302 and the end caps 306A, 306B. The wire 310 is arranged within and extends along the length of the chamber 312. The wire 310 is held in place by wire mounts 308A, 308B, which secure to the ends caps 306A, 306B, respectively. The end caps 306A, 306B may electrically insulate the wire 310 from the tube 302 when either/both are charged.

The wire 310 axially or longitudinally extends through the tube 302 along the Z-axis. In some implementations, the wire 310 is centrally located in the tube and is secured at or adjacent to both ends of the tube 302. The wire 310 extends through the end caps 306A, 306B and may connect to a processor.

After the wire 310 is secured in a tube 302 and the tube is filled with the desired gas or gas mixture, the tube is hermetically sealed by end caps 306A, 306B. Any suitable procedure may be used to do this. The end cap 306A with the wire mount 308A may be used to close one end of the tube 302, with the anode wire 310 extending through that end cap 306A to the exterior of the tube 302, and the end cap 306B with the wire mount 308B may be used to close one end of the tube 302, with the anode wire 310 extending through that end cap 306B to the exterior of the tube 302.

The tube 302 can include a rigid material such as a metal. In some implementations, the housing material can include titanium, aluminum, stainless steel, or alloys thereof. However, the tube material is not limited thereto, and various other materials can be used. The end caps 306A, 306B can also include a rigid material. In some implementations, the end caps 306A, 306B can include the same metal material as the tube 302, with the tube 302 electrically insulated from the end caps 306A, 306B. In some implementations, the end caps 306A, 306B can include a different material from the tube 302. For example, the end caps 306A, 306B can include a ceramic. In some implementations, the sensor 300 may be secured to a wall or surface at the end caps 306A, 306B. For example, the sensor 300 can be suspended within a chamber and mounted to the chamber walls on either side by securing the end caps 306A, 306B to either chamber wall. The support bracket 304 would support the tube 302 and help prevent bending of the tube 302 along its length by increasing its rigidity when mounted from the end caps 306A, 306B.

In some implementations, the distance between the top of wire 310 and the inside surface of the tube 302 is between 0.125-12 inches, and the length of the tube 302 is between 2-120 inches. The tube may have an active length between 1-120 inches. In some implementations, the diameter of the tube 302 is between 0.125-12 inches, and as a more specific example, the diameter of the tube 302 may be between 0.30-0.35 inches. In some implementations, the thickness of the wall of tube 302 is between 0.005-0.090 inches.

In embodiments, the tube 302 and wire 310 have an applied voltage which increases as a charged particle moves from the tube 302 to the wire 310 in order to attract the charged particles towards the wire 310 acting as an anode. For example, the tube 302 may have an applied voltage of 500 V and the wire 300 may have an applied voltage of 2,000 V. Similarly, in another embodiment, the tube 302 may have an applied voltage of −2,000 V and the wire 300 may have an applied voltage of 0 V, being connected to ground.

The sensor 300 is filled with a neutron sensitive gas, such as He-3. While in the operation of the sensor 300, neutrons passing through the sensor 300 interact with the gas in the sensor 300. Also, while in operation, the tube 302 and the wire 310 are charged so that the tube 302 acts as a cathode, and the wire 310 acts as an anode. This interaction results in electrical pulse signals in the wire 310, and the pulses in the wire 310 are collected and analyzed by a processor. The distribution of sensors 300 can include a multitude of tubes.

The support bracket 304 includes a mounting portion 305 and is secured along the entire length of the tube 302 along the Z-axis. In some implementations, the support bracket 304 is L-shaped. The support bracket 304 may be coupled to the tube 302 along seam 314. The seam 314 may be a laser welded portion between the tube 302 and the support bracket 304. The support bracket 304 extends radially outward of the tube 302 in the −Y direction. In some implementations, the support bracket 304 may be the same material as the tube 302, or may be a different, non-conductive material. In some implementations, the support bracket material can include titanium, aluminum, or alloys thereof. However, the housing material is not limited thereto, and various other materials can be used, such as a ceramic.

Due to the relationship between the tube 302 and the support bracket 304 coupled along its entire length, the support bracket 304 stiffens the tube 302 to help prevent distortion of the tube 302 due to a magnetic dipping effect. The magnetic dipping effect is caused by the large potential charge difference between the tube 302 and the wire 310 while the sensor 300 is in operation. If when in operation the tube 302 were to deflect enough to contact the wire 310, the wire 310 would weld itself to the tube 302 due to the large voltages within the components, rendering the sensor 300 useless. Additionally, the arrangement of the support bracket 304 being arranged on the underside of the sensor 300 helps eliminate distortion in the detection signal since neutrons would not need to pass through a bracket arranged on the front side of the sensor 300. This may allow for smaller diameter sensors 300 to be used in a detector array, leading to a finer resolution since the sensors are both straighter and closer together.

FIG. 3C depicts a detector assembly 30 formed from a plurality of sensors 300. With the arrangement of the sensors 300 illustrated in FIG. 3C, the sensors 300 are arranged in parallel rows. The gap between the tubes 302 of adjacent sensors 300 is between 0.001-0.005 inches, and more specifically set at 0.002 inches. This uniform spatial arrangement may be achieved by mounting the sensors 300 to the frame 320 using support brackets 304. Since the support brackets 304 extend along the entire length of the tube 302, there may be no need for additional support brackets or frames along the length of the tubes 302.

Still referring to FIG. 3C, the frame 320 may further include channels 322 arranged within the frame 320. The channels 322 may correspond to the shape of the support bracket 304 of the sensor 300. The support brackets 304, specifically the mounting portion 305, may be held within the channels using an adhesive, welded material, or mechanical means. For example, a friction fit could be used to couple the sensors 300 to the frame 320.

FIG. 3D depicts a detector assembly 32 formed from a plurality of sensors 300. With the arrangement of the sensors 300 illustrated in FIG. 3D, the sensors 300 are arranged in parallel rows. The gap between the tubes 302 of adjacent sensors 300 is between 0.001-0.005 inches, and more specifically set at 0.002 inches. This uniform spatial arrangement may be achieved by mounting the sensors 300 to the frame 320 using support brackets 304 and bolts 324. Since the support brackets 304 extend along the entire length of the tube 302, there may be no need for additional support brackets or frames along the length of the tubes 302. A plurality of holes may be arranged within the mounting portion 305 of the support bracket 304, with corresponding holes arranged within the frame 320. The support brackets 304 may also be secured to the frame 320 using an adhesive or being directly welded to the frame 320.

As set forth herein, a detector according to exemplary embodiments of the present disclosure includes a sensor including a support bracket extending along the entire length of the tube in order to provide rigidity and stiffness to the tube to prevent deflection of the tube due to the magnetic dipping effect.

Certain exemplary implementations have been described to provide an overall understanding of the principles of the structure, function, manufacture, and use of the systems, devices, and methods disclosed herein. One or more examples of these implementations have been illustrated in the accompanying drawings. Those skilled in the art will understand that the systems, devices, and methods specifically described herein and illustrated in the accompanying drawings are non-limiting exemplary implementations and that the scope of the present invention is defined solely by the claims. The features illustrated or described in connection with one exemplary implementation may be combined with the features of other implementations. Such modifications and variations are intended to be included within the scope of the present invention. Further, in the present disclosure, like-named components of the implementations generally have similar features, and thus within a particular implementation each feature of each like-named component is not necessarily fully elaborated upon.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

One skilled in the art will appreciate further features and advantages of the invention based on the above-described implementations. Accordingly, the present application is not to be limited by what has been particularly shown and described, except as indicated by the appended claims. All publications and references cited herein are expressly incorporated by reference in their entirety.

The present disclosure is not limited to the exemplary embodiments described herein and can be embodied in variations and modifications. The exemplary embodiments are provided merely to allow one of ordinary skill in the art to understand the scope of the present disclosure, which will be defined by the scope of the claims. Accordingly, in some embodiments, well-known operations of a process, well-known structures, and well-known technologies are not be described in detail to avoid obscure understanding of the present disclosure. Throughout the specification, same reference numerals refer to same elements.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinabove, although the present disclosure is described by specific matters such as concrete components, and the like, the exemplary embodiments, and drawings, they are provided merely for assisting in the entire understanding of the present disclosure. Therefore, the present disclosure is not limited to the exemplary embodiments. Various modifications and changes can be made by those skilled in the art to which the disclosure pertains from this description. Therefore, the spirit of the present disclosure should not be limited to the above-described exemplary embodiments, and the following claims as well as all technical spirits modified equally or equivalently to the claims should be interpreted to fall within the scope and spirit of the disclosure.

What is claimed is:

1. A sensor, comprising:
a tube having a through-bore therein;
a wire arranged within the through-bore of the tube, wherein the wire is electrically insulated from the tube; and
a support bracket secured along the entire length of the tube configured to provide rigidity along the length of the sensor.

2. The sensor of claim 1, wherein the tube is charged as a cathode and the wire is charged as an anode.

3. The sensor of claim 2, wherein the through-bore of the tube is filled with He-3 gas.

4. The sensor of claim 1, wherein the support bracket attaches the sensor to a frame.

5. The sensor of claim 4, wherein the support bracket is attached to the frame via at least on bolt.

6. The sensor of claim 1, wherein the support bracket is L-shaped or T-shaped.

7. The sensor of claim 1, wherein the support bracket is arranged within a complementary-shaped channel within the frame.

8. The sensor of claim 1, wherein the support bracket extends radially outward from the tube.

9. The sensor of claim 1, further comprising a first cap arranged on a distal end of the tube and a second cap arranged on the proximal end of the tube, wherein the first cap and second cap electrically insulate the tube from the wire.

10. The sensor of claim 9, wherein the sensor is attached to a first surface at the first cap and a second surface at the second cap.

11. The sensor of claim 1, wherein the bracket comprises a radially extending portion and a mounting portion.

12. A detector assembly, comprising:
a plurality of sensors, wherein each sensor comprises:
a tube having a through-bore therein;
a wire arranged within the through-bore of the tube, wherein the wire is electrically insulated from the tube; and
a support bracket secured along the entire length of the tube configured to provide rigidity along the length of the sensor.

13. The detector assembly of claim 12, wherein the tube is charged as a cathode and the wire is charged as an anode.

14. The detector assembly of claim 13, wherein the through-bore of the tube is filled with He-3 gas.

15. The detector assembly of claim 14, wherein the support bracket secures each of the plurality of sensors to a frame.

16. The detector assembly of claim 15, wherein the support bracket is secured to the frame via at least on bolt.

17. The detector assembly of claim 16, wherein the support bracket is L-shaped or T-shaped.

18. The detector assembly of claim 17, wherein the support bracket extends radially outward from the tube.

19. The detector assembly of claim 18, further comprising a first cap arranged on a distal end of the tube and a second cap arranged on the proximal end of the tube, wherein the first cap and second cap electrically insulate the tube from the wire.

20. The detector assembly of claim 19, wherein each of the plurality of sensors are secured to a first surface at the first cap and a second surface at the second cap.
